(19) United States
(12) Patent Application Publication
(10) Pub. No.: US 2009/0056567 A1
(43) Pub. Date: Mar. 5, 2009

(54) PRINTING APPARATUS

(75) Inventors: Yukio Ando, Tomi-city (JP); Masahiro Hayashi, Hachioji-city (JP)

Correspondence Address: DITTHAVONG MORI & STEINER, P.C., 918 Prince St., Alexandria, VA, 22314, US

(73) Assignees: MIMAKI ENGINEERING CO., LTD., Tomi-city (JP); WIZTEC CO., LTD., Hachioji-city (JP)

(21) Appl. No.: 12/198,316

(22) Filed: Aug. 26, 2008

(30) Foreign Application Priority Data
Aug. 30, 2007 (JP) 2007-224788

(51) Int. Cl. B41C 1/06; B41D 7/00

(52) U.S. Cl. 101/34; 101/33

(57) ABSTRACT

A printing apparatus for printing on a print substrate by sequentially conducting a plurality of processing operations. The printing apparatus includes a pallet configured to receive the print substrate, and work station units each comprising a conveyer mechanism configured to convey the pallet and a work mechanism configured to conduct a predetermined processing operation to the print substrate on the pallet. A plurality of the work station units are aligned adjacent to each other, and the work station units are configured to be replaceable or rearrangeable to change the sequence of the plurality of processing operations.

### CROSS-REFERENCE TO RELATED APPLICATION

The present application claims priority to Japanese Patent Application No. 2007-224788, filed on Aug. 30, 2007, the entire contents of which are herein incorporated by reference.

### BACKGROUND OF THE INVENTION

1. Field of the Invention

The present invention relates to a printing apparatus for printing intended characters, images, etc. on a print substrate, such as a T-shirt.

2. Discussion of the Background

Conventionally, as an apparatus and a method for printing characters, images, etc., on a print substrate, such as a T-shirt, screen printing has been known in which a plurality of screens corresponding to printing colors are prepared and are used to print each color on the surface of the print substrate so that printed colors are overlapped. Since the screen printing requires a plurality of exclusive screens corresponding to designs and colors, making the screens is troublesome and expensive. Thus, screen printing is not suitable for high-mix, low-volume production type printing.

Recently, methods for printing on a print substrate such as a T-shirt by using an inkjet printer to eject ink droplets directly on the print substrate have been carried out. JP-A-2002-154247 and JP-A-2007-031888 describe such a printing apparatus and method using an inkjet printer. The contents of these applications are herein incorporated by reference in their eintireties

When printing characters, images, etc. on a print substrate made of cloth, such as a T-shirt, by using an inkjet printer, it is required to conduct a lot of processing steps such as a preprocessing step for the purpose of preventing ink blurring and a post-processing step for the purpose of protecting images printed on the surface of the print substrate. In industrial printing applications, there are apparatuses in which various working devices are located along a long belt conveyer so that print substrates are conveyed by the long belt conveyer and stopped at every working position where the working device is placed and the print substrate is processed according to the processing steps such as the aforementioned preprocessing step.

For printing apparatuses of a type for high-mix, low-volume production, there may be a need to increase or reduce printing steps, and to change a layout according to the kind of print substrate and the production conditions. However, the printing apparatuses described above cannot meet such needs, because in such apparatuses it is difficult to replace or rearrange the conveyer line for conveying print substrates.

### SUMMARY OF THE INVENTION

The present invention advantageously provides a printing apparatus for printing on a print substrate by sequentially conducting a plurality of processing operations. The printing apparatus includes a pallet configured to receive the print substrate, and work station units each comprising a conveyer mechanism configured to convey the pallet and a work mechanism configured to conduct a predetermined processing operation to the print substrate on the pallet. A plurality of the work station units are aligned adjacent to each other, and the work station units are configured to be replaceable or rearrangeable to change the sequence of the plurality of processing operations.

The present invention further advantageously provides a method of printing on a print substrate. The method includes providing a print substrate on a pallet, and providing a plurality of work station units aligned adjacent to each other, where the plurality of work station units each include a conveyer mechanism configured to convey the pallet and a work mechanism configured to conduct a predetermined processing operation to the print substrate on the pallet. The method also includes conveying the pallet using the conveyer mechanisms, and sequentially conducting a plurality of the predetermined processing operations to the print substrate on the pallet, where the plurality of work station units are configured to be replaceable or rearrangeable to change the sequence of the plurality of the predetermined processing operations.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 is a side view showing a schematic structure of a printing apparatus according to an embodiment of the present invention;

FIG. 2 is a perspective view showing structures of a loading station unit, a printing station unit, and a collecting station unit as components of the printing apparatus;

FIG. 3 is a perspective view showing a structure of a pallet on which print substrates to be printed by the printing apparatus are placed;

FIG. 4 is a perspective view showing a structure of a conveyer unit as a component of the printing apparatus;

FIG. 5 is a perspective view showing a structure of each of upper and lower conveyer mechanisms as parts of the conveyer unit;

FIG. 6 is a plan view of the conveyer unit;

FIG. 7(A) is a plan view and FIG. 7(B) is a side view (B) showing the structure of the loading station unit or the collecting station unit;

FIG. 8 is a side view showing the structure of an anteroposterior moving mechanism as a part of a printer unit of the printing station unit;

FIG. 9 is a perspective view showing a driving system of driving sprockets in the anteroposterior moving mechanism;

FIG. 10 is a partial sectional view showing a peripheral structure of a fitting member in the left-side anteroposterior moving mechanism; and

FIG. 11 is a partial sectional view showing a peripheral structure of a fitting member in the right-side anteroposterior moving mechanism.

### DETAILED DESCRIPTION OF EXEMPLARY EMBODIMENTS OF THE INVENTION

Embodiments of the present invention will be described hereinafter with reference to the accompanying drawings. In the following description, the constituent elements having substantially the same function and arrangement are denoted by the same reference numerals, and repetitive descriptions will be made only when necessary.

Embodiments of the present invention advantageously provide a printing apparatus which can meet needs to increase or reduce of printing steps and to change a layout according to the kind of print substrates and the production condition.

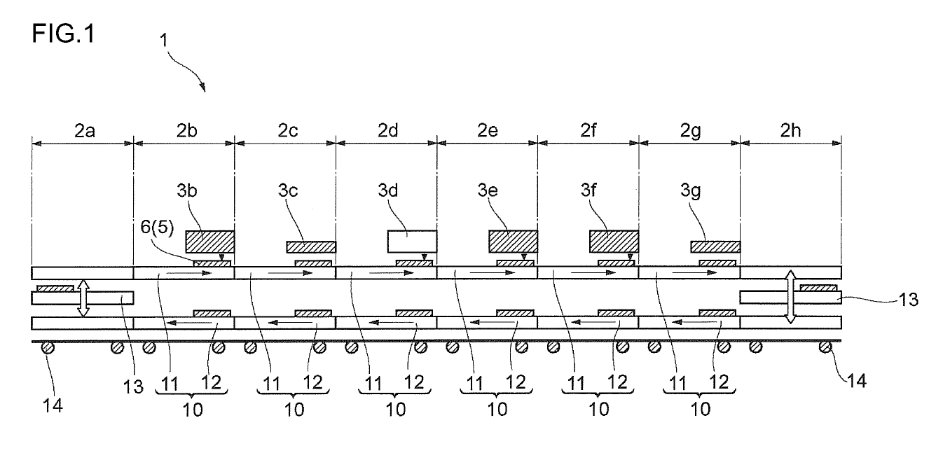

For example, a printing apparatus (e.g., printing apparatus 1 of the embodiment in FIG. 1) for printing intended images or the like on a print substrate (e.g., print substrates 5) by sequentially conducting a plurality of processing operations to the print substrate is provided. The printing apparatus includes a pallet (e.g., pallet 6) on which the print substrate is placed, and work station units (e.g., work station units 2b-2g) each including a conveyer mechanism (e.g., upper conveyer mechanism 11 of conveyer unit 10) for conveying the pallet and a work mechanism (e.g., each of work units 3b-3g) for conducting a predetermined processing operation to the print substrate placed on the pallet. A plurality of the work station units according to the processing operations are aligned adjacent to each other, pallet receiving portions and pallet let-off portions of the conveyer mechanisms are located to allow delivery of the pallet between the conveyer mechanisms of the work station units, and the steps of the processing operations are allowed to be changed and set by replacing or rearranging each of the work station units.

The aforementioned printing apparatus can further include a circulating conveyer system (e.g., elevation units 13 of loading station unit 2a and collecting station unit 2h), which connects the pallet let-off portion of an anterior end work station unit and the pallet receiving portion of a posterior end work station unit so as to allow delivery of the pallet from the anterior end work station unit to the posterior end work station unit. The anterior end work station unit is one of the work station units disposed at the anterior end of a line of the work station units aligned adjacent to each other and the posterior end work station unit is another one of the work station units disposed at the posterior end of the line.

The printing apparatus includes a pallet on which the print substrate is placed, and a plurality of work station units each including a conveyer mechanism for conveying the pallet and a work mechanism for conducting a predetermined processing operation to the print substrate placed on the pallet, wherein the plurality of the work station units are aligned adjacent to each other to allow delivery of the pallet between the conveyer mechanisms of the work station units. According to this structure, the processing steps for the printing operation are allowed to be changed and set by replacing or rearranging each of the work station units. Therefore, it is possible to flexibly meet needs for increase or reduction of printing steps and change of layout according to the kind of print substrates and the production condition, thereby making the printing apparatus suitable for high-mix low-volume production type printing.

Further, the printing apparatus can further include a circulating conveyer system that connects the pallet let-off portion of an anterior end work station unit and the pallet receiving portion of a posterior end work station unit so as to allow delivery of the pallet from the anterior end work station unit to the posterior end work station unit, wherein the anterior end work station unit is one of the work station units disposed at the anterior end of a line of the work station units aligned adjacent to each other and the posterior end work station unit is another one of the work station units disposed at the posterior end of the line. According to this structure, the pallet is allowed to be circulated among the respective work station units, thereby improving the efficiency of print work.

Hereinafter, a preferred embodiment of the present invention will be described with reference to the attached drawings.

FIG. 1 shows a schematic structure of a printing apparatus 1 according to an embodiment of the present invention. The printing apparatus 1 comprises eight work station units (a loading station unit 2a, a preprocessing station unit 2b, a first drying station unit 2c, an undercoating station unit 2d, a printing station unit 2e, an post-processing station unit 2f, a second drying station unit 2g, and a collecting station unit 2h) that are aligned adjacent to each other. The station units 2b through 2g are provided corresponding to respective processing operations to be conducted to a print substrate 5, such as T-shirts, and each comprise a work unit (a preprocessing unit 3b, drying units 3c and 3g, an undercoating unit 3d, a printing unit 3e, an post-processing unit 3f) for conducting each processing operation.

Each of the station units 2b through 2g has a conveyer unit 10 for conveying a pallet 6, which holds the print substrate 5 thereon. The conveyer unit 10 comprises an upper conveyer mechanism 1 1 for conveying the pallet 6 holding the print substrate 5 thereon at a working position as will be described later for each work unit (the preprocessing unit 3b, the drying units 3c and 3g, the undercoating unit 3d, the printing unit 3e, the post-processing unit 3f), and a lower conveyer mechanism 12 for conveying the empty pallet 6 (without holding the print substrate 5). The upper conveyer mechanisms 1 1 and the lower conveyer mechanisms 12 are placed in a uniform way through the respective station units 2b through 2g such that ends as the pallet receiving portions and the pallet let-off portions of the respective upper conveyer mechanisms 1 1 are surely abutted to each other and also ends as the pallet receiving portions and the pallet let-off portions of the respective lower conveyer mechanisms 12 are surely abutted to each other so as to allow the delivery of the pallet 6 between the station units.

The loading station unit 2a and the collecting station unit 2h each have an elevation unit 13 for carrying the pallet 6 between the upper conveyer mechanism 11 and the lower conveyer mechanism 12. The elevation units 13 move up and down to abut itself to the ends as the pallet receiving portion and the pallet let-off portion of the upper conveyer mechanism 11 and the lower conveyer mechanism 12 so as to allow the delivery of the pallet 6 between the upper conveyer mechanism 11 and the lower conveyer mechanism 12. The pallet 6 can be conveyed and circulated through the respective station units 2a through 2h by the elevation units 13 and the upper and lower conveyer mechanisms 11, 12 (the respective conveyer units 10).

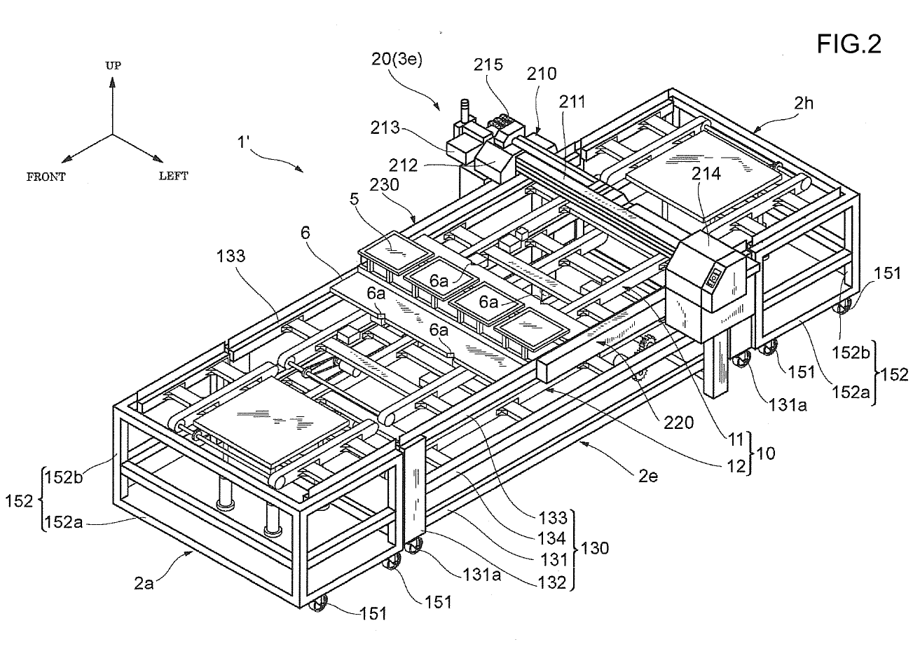

In each of the station units 2a through 2h, each elevation unit 13 or each work unit (the preprocessing unit 3b, the drying units 3c and 3g, the undercoating unit 3d, the printing unit 3e, the post-processing unit 3f) and each conveyer unit 10 are mounted to a frame body (a conveyer frame 130, an elevation frame 152 in FIG. 2) of each station unit and thus can be replaced or rearranged integrally with each frame body. Each frame body has wheels 14 (wheels 131a, wheels 151 in FIG. 2), which are fixed to the bottom thereof and have locking mechanisms, respectively, thereby easily allowing the movement of each of the station units 2a through 2h.

In the printing apparatus 1, a print substrate 5 is first put on the pallet 6 by an operator in the loading station unit 2a. The pallet 6 holding the print substrate 5 thereon is moved by the elevation unit 13 toward the upper conveyer mechanism 11 of the preprocessing station unit 2b and is then conveyed to the next station unit, i.e., the preprocessing station unit 2b.

The preprocessing station unit 2b comprises the preprocessing unit 3b having a preprocessing printer or the like for conducting a preprocessing step by applying base coating material (transparent ink) to the surface of the print substrate 5 (in a range where intended characters, images, etc. are printed) to previously coat the surface of the print substrate 5. The preprocessing step is conducted for the purpose of preventing ejected inks, applied at the undercoating station unit 2d and the printing station unit 2e, from penetrating inside the print substrate 5 and preventing ink blurring. The pallet 6 conveyed from the loading station unit 2a to the preprocessing station unit 2b is moved to a working position, as will be described later, of the preprocessing unit 3b via a standby position, as will be described later, by the upper conveyer mechanism 11. The print substrate 5 on the pallet 6 is subjected to the aforementioned preprocessing step while the pallet 6 is held at the working position and is then conveyed to the next station unit, i.e., the first drying station unit 2c.

The first drying station unit 2c comprises the drying unit 3c having a heater or the like for drying the base coating material (transparent ink) which was applied at the preprocessing station unit 2b (the preprocessing unit 3b) to coat the surface of the print substrate 5. The drying step is conducted for the purpose of preventing adhesion of inks applied at the undercoating station unit 2d and the printing station unit 2e from being poor and thus preventing the print quality from being poor. The pallet 6 conveyed from the preprocessing station unit 2b to the first drying station unit 2c is moved to a working position of the drying unit 3c via a standby position by the upper conveyer mechanism 11. The print substrate 5 on the pallet 6 is subjected to the aforementioned drying step while the pallet 6 is held at the working position and is then conveyed to the next station unit, i.e., the undercoating station unit 2d.

The undercoating station unit 2d comprises the undercoating unit 3d having an undercoat printer or the like for conducting an undercoating process by applying undercoating material (white ink) on the surface (the surface of the base coating material) of the print substrate 5 preprocessed at the preprocessing station unit 2b (the preprocessing unit 3b). The undercoating process allows the intended color characters, images, etc. to be printed without affecting the color of ink ejected at the printing station unit 2e by the color of the print substrate 5 itself, thereby improving the chromogenic characteristics. The pallet 6 conveyed from the first drying station unit 2c to the undercoating station unit 2d is moved to a working position of the undercoating unit 3d via a standby position by the upper conveyer mechanism 11. The print substrate 5 on the pallet 6 is subjected to the aforementioned undercoating process while the pallet 6 is held at the working position and is then conveyed to the next station unit, i.e., the printing station unit 2e.

The printing station unit 2e comprises a printing unit 3e having an inkjet printer or the like for conducting a printing step for printing intended characters, images, etc. by ejecting ink droplets from inkjet nozzle onto the surface of the print substrate 5 undercoated at the undercoating station unit 2d (the undercoating unit 3d). The pallet 6 conveyed from the undercoating station unit 2d to the printing station unit 2e is moved to a working position of the printing unit 3e via a standby position by the upper conveyer mechanism 11. The print substrate 5 on the pallet 6 is subjected to the aforementioned printing step while the pallet 6 is held at the working position and is then conveyed to the next station unit, i.e., the post-processing station unit 2f.

The post-processing station unit 2f comprises the post-processing unit 3f having an post-processing printer or the like for conducting an post-processing step by applying protective coating material (transparent ink) to the surface of the characters, images, etc. of the print substrate 5 printed at the printing station unit 2e (the printing unit 3e) to protect and coat the surface. The post-processing step is conducted for the purpose of preventing the ejected ink of the intended characters, images, etc. printed at the printing station unit 2e (the printing unit 3e) from peeling off the surface of the print substrate 5. The pallet 6 conveyed from the printing station unit 2e to the post-processing station unit 2f is moved to a working position of the post-processing unit 3f via a standby position by the upper conveyer mechanism 11. The print substrate 5 on the pallet 6 is subjected to the aforementioned post-processing step while the pallet 6 is held at the working position and is then conveyed to the next station unit, i.e., the second drying station unit 2g.

The second drying station unit 2g comprises the drying unit 3g having a heater or the like for drying the protective coating material (transparent ink) protecting and coating the surface of the printed characters, images, etc. of the print substrate 5 applied at the post-processing station unit 2f (the post-processing unit 3f). By this drying step, all of the processing operations for the print substrate 5 are completed, thus finishing the print substrate 5 with printed intended characters, images, etc. thereon. The pallet 6 conveyed from the post-processing station unit 2f to the second drying station unit 2g is moved to a working position of the drying unit 3g via a standby position by the upper conveyer mechanism 11. The print substrate 5 on the pallet 6 is subjected to the aforementioned drying step while the pallet 6 is held at the working position and is then conveyed to the next station unit, i.e., the collecting station unit 2h.

In the collecting station unit 2h, the finished print substrate 5 on the pallet 6 conveyed from the second drying station unit 2g after the respective processing operations is collected by the operator. The empty pallet 6 after the print substrate 5 is collected is moved by the elevation unit 13 toward the lower conveyer mechanism 12 of the second drying station unit 2g and is conveyed to the loading station unit 2a through the post-processing station unit 2f, the printing station unit 2e, the undercoating station unit 2d, the first drying station unit 2c, and the preprocessing station unit 2b in this order by the lower conveyer mechanisms 12. Then, at the loading station unit 2a, a new print substrate 5 is put on the empty pallet 6 and is subjected to the aforementioned steps.

The structure of the conveyer unit 10 (the upper conveyer mechanism 11 and the lower conveyer mechanism 12) of each of the station unit 2b through 2g and the structure of the elevation unit 13 of each of the loading station unit 2a and the collecting station unit 2h will be described in detail with regard to FIG. 2 through FIG. 7. FIG. 2 shows a printing apparatus 1′ comprising a loading station unit 2a, a printing station unit 2e, and a collecting station unit 2h which are aligned adjacent to each other. For the sake of convenience, in FIG. 2 through FIG. 6, directions indicated by arrows “UP”, “FRONT”, AND “LEFT” will be upward, forward, and leftward directions in the following description.

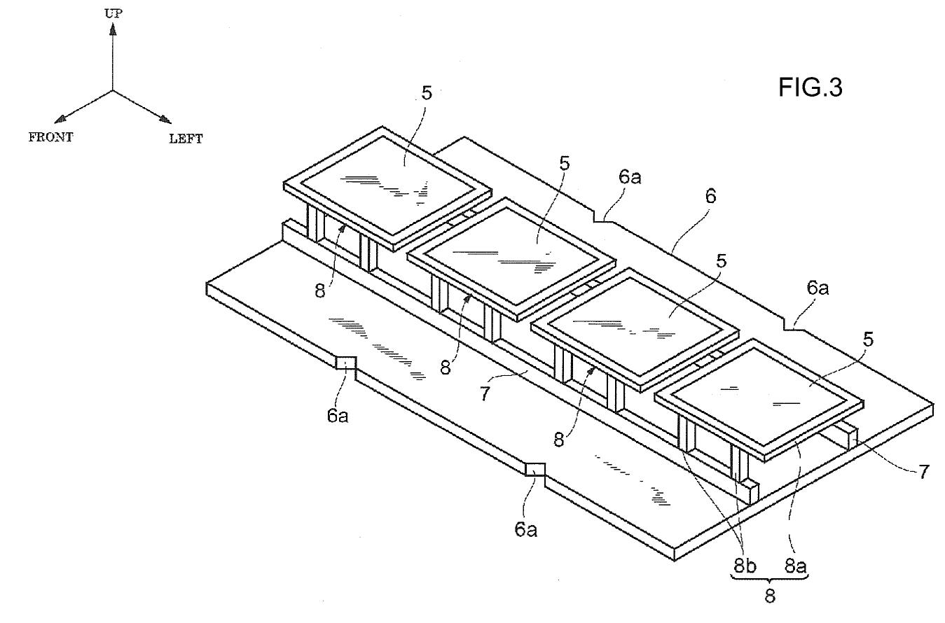

The printing station unit 2e comprises a conveyer unit 10, which is composed of an upper conveyer mechanism 11 for conveying a pallet 6 holding a print substrate 5 thereon, a lower conveyer mechanism 12, and a printer unit 20 (a printing unit 3e) as will be described later. As show in FIG. 3, the pallet 6 is formed into a rectangular plate-shape and has a pair of long table supporting members 7 fixed to the upper surface thereof. Disposed on the table supporting members 7 are a plurality (four in this embodiment) of loading tables 8 that are aligned in the lateral direction. Each loading table 8 comprises a top panel 8a having a rectangular plate shape for holding each print substrate 5 thereon and four leg members 8b extending downwardly from the lower surface of the top panel 8a. The pallet 6 is provided with four cutouts 6a; two of which are formed in each of the front and rear side surfaces thereof and which can come in contact with to locating pins 141a of first sensors 141 and locating pins 146a of second sensors 146.

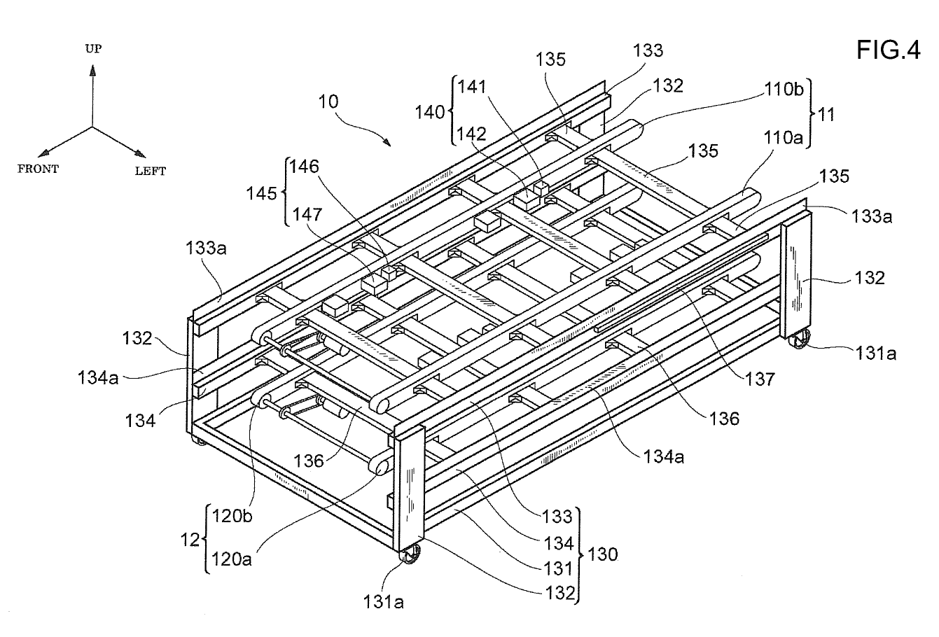

As shown in FIG. 4, the conveyer unit 10 has a conveyer frame 130 comprising a rectangular frame body 131 that has a plurality of wheels 131a having locking mechanisms and is located at a predetermined height from a floor, four frame columns 132 standing on side surfaces near the four corners of the frame body 131, a pair of upper frame members 133 that are fixed to extend between upper portions of the left-side frame columns 132 and between upper portions of right-side frame columns 132, and a pair of lower frame members 134 that are fixed to extend between lower portions of the left-side frame columns 132 and between lower portions of right-side frame columns 132. An upper conveyer mechanism 11 is supported along the upper frame members 133 and a lower conveyer mechanism 12 is supported along the lower frame members 134, thereby making a two-stage structure. The upper frame members 133 and the lower frame members 134 have guide walls 133a, 134a, respectively, which are disposed on the outer surfaces thereof to extend upward along the outer surfaces. The guide walls 133a, 134a prevent the pallets 6 on the upper conveyer mechanism 11 and the lower conveyer mechanism 12 from deviating to the left or the right.

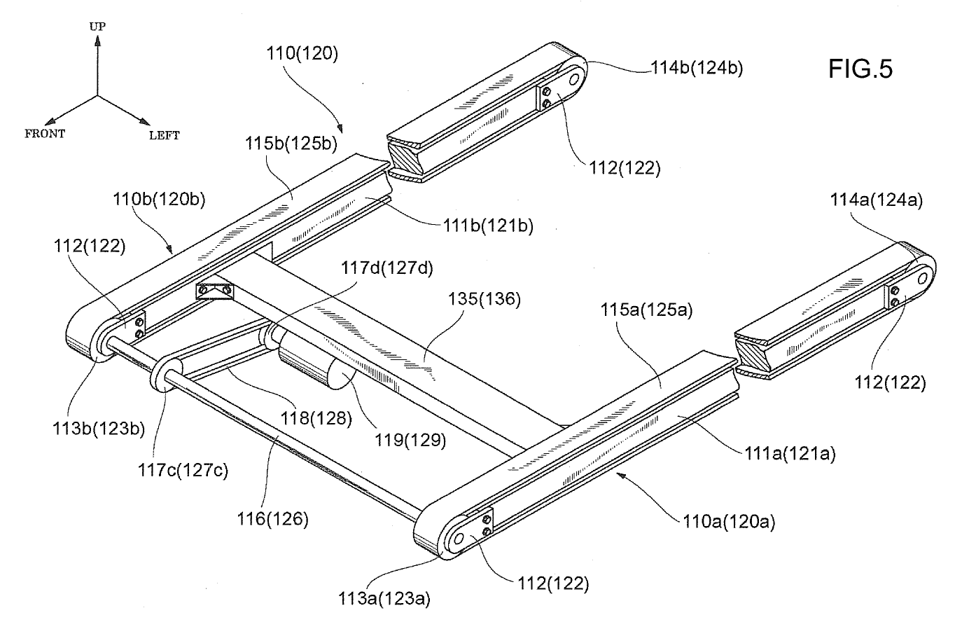

The upper conveyer mechanism 11 has a pair of upper belt conveyers 110a, 110b that are supported between the upper frame members 133 such that the upper belt conveyers 110a, 110b are spaced apart from each other by a predetermined distance to extend in parallel to each other and horizontally by using a plurality of long supporting frame members 135. As shown in FIG. 5, the upper belt conveyers 110a, 110b comprise long body members 111a, 111b, driving pulleys 113a, 113b and driven pulleys 114a, 114b rotatably mounted at the ends of the long body members 111a, 111b via mounting members 112, and endless conveyer belts 115a, 115b, which are wound around the driving pulleys 113a, 113b and the driven pulleys 114a, 114b to extend therebetween. The left and right driving pulleys 113a, 113b are connected to each other through a driving shaft 116. Attached to the driving shaft 116 is a first sprocket 117c. A driving chain 118 is wound around the first sprocket 117c and a second sprocket 117d to extend therebetween. The second sprocket 117d is rotated by a driving motor 119, which is fixed to the lower surface of the supporting frame member 135, whereby the first sprocket 117c is rotated through the driving chain 118 and the driving pulleys 113a, 113b are rotated in synchronism with each other via the driving shaft 116. That is, the left and right conveyer belts 115a, 115b are rotated and moved in synchronism with each other by the driving motor 119 so as to move the pallet 6 on the conveyer belts 115a, 115b rearward.

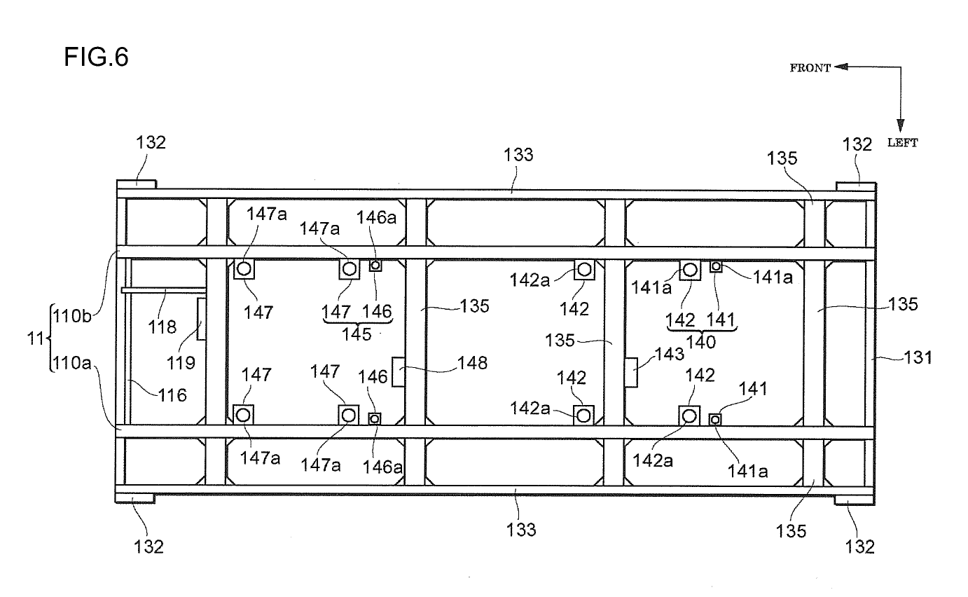

At predetermined positions in the feeding direction (the anteroposterior direction) of the upper conveyer mechanism 11, as shown in FIG. 6, a first holding mechanism 140 and a second holding mechanism 145 for locating and holding the pallet 6 conveyed by the upper conveyer mechanism 11 are disposed on the upper conveyer mechanism 11. The first holding mechanism 140 comprises first sensors 141 for sending a signal when the pallet 6 is located at a preset first holding position (a working position where the printer unit 20 as will be described later prints on the print substrate 5), first air cylinders 142 for lifting up the pallet 6 to space the pallet 6 apart from the upper conveyer mechanism 11 (the conveyer belts 115a, 115b) when the pallet 6 is located at the first holding position, and a first controller 143 which receives the signal, indicating that the pallet 6 is located at the first holding position, from the first sensors 141 and thus sends a control signal to the first air cylinders 142.

The first sensors 141 each have a locating pin 141a that is expandable in the vertical direction and are disposed on the inner sides of the upper belt conveyers 110a, 110b, respectively (the total number of the first sensors 141 is two in this embodiment). The locating pins 141a in the expanded state come in contact with the cutouts 6a (see FIG. 2 or FIG. 3), formed on the rear side of the pallet 6, when the pallet 6 conveyed on the upper belt conveyers 110a, 110b is located at the first holding position. It should be noted that the locating pins 141a of the first sensors 141 in the contracted state do not come in contact with the pallet 6 (the cutouts 6a). The first sensors 141 detect pressing force produced when the cutouts 6a of the pallet 6 collide with the locating pins 141a and thus sends a signal, indicating that the pallet 6 is located at the first holding position, to the first controller 143.

The first controller 143 is connected to the first sensors 141 and the first air cylinders 142 via cables (not shown). Through the cables, the first controller 143 receives the signal, indicating that the pallet 6 is located at the first holding position, from the first sensors 141 and sends a control signal to the first air cylinders 142. The first controller 143 is mounted to the supporting frame member 135 between the upper belt conveyers 110a, 110b.

The first air cylinders 142 each have a holding pin 142a that is expandable in the vertical direction and are disposed on the upper belt conveyers 110a, 110b two by two at positions corresponding to the position of the pallet 6 being in the first holding position (the total number of the first air cylinders 142 is four in this embodiment). The holding pins 142a are expandable according to the control signal of the first controller 143. The holding pins 142a when being expanded come in contact with the lower surface of the pallet 6 and lift up the pallet 6, thereby holding the pallet 6 spaced apart from the conveyer belts 115a, 115b of the upper belt conveyers 110a, 110b. As the holding pins 142a of the first air cylinders 142 are contracted according to the control signal of the first controller 143 from the state holding the pallet 6 spaced apart from the conveyer belts 115a, 115b, the pallet 6 is returned to be put on the conveyer belts 115a, 115b.

The second holding mechanism 145 has a similar structure as the aforementioned first holding mechanism 140 and comprises second sensors 146, 146 for sending a signal when the pallet 6 is located at a preset second holding position (a position before (in front of) the first holding position in the conveying direction, that is, a standby position before the first holding position not to lap over the working position of the printer unit 20 as will be described later), second air cylinders 147 for lifting up the pallet 6 to space the pallet 6 apart from the upper conveyer mechanism 11 when the pallet 6 is located at the second holding position, and a second controller 148 which receives the signal, indicating that the pallet 6 is located at the second holding position, from the second sensors 146 and thus sends a control signal to the second air cylinders 147.

The second sensors 146 each have a locating pin 146a that is expandable in the vertical direction and are disposed on the inner sides of the upper belt conveyers 110a, 110b, respectively (the total number of the second sensors 146 is two in this embodiment). The locating pins 146a in the expanded state come in contact with the cutouts 6a (see FIG. 2 or FIG. 3), formed on the rear side of the pallet 6, when the pallet 6 conveyed on the upper belt conveyers 110a, 110b is located at the second holding position. It should be noted that the locating pins 146a of the second sensors 146 in the contracted state do not come in contact with the pallet 6 (the cutouts 6a). The second sensors 146 detect pressing force produced when the cutouts 6a of the pallet 6 collide with the locating pins 146a and thus sends a signal, indicating that the pallet 6 is located at the second holding position, to the second controller 148.

The second controller 148 is connected to the second sensors 146 and the second air cylinders 147 via cables (not shown). Through the cables, the second controller 148 receives the signal, indicating that the pallet 6 is located at the second holding position, from the second sensors 146 and sends a control signal to the second air cylinders 147. The second controller 148 is mounted to the supporting frame member 135 between the upper belt conveyers 110a, 110b.

The second air cylinders 147 each have a holding pin 147a that is expandable in the vertical direction and are disposed on the upper belt conveyers 110a, 110b two by two at positions corresponding to the position of the pallet 6 being in the second holding position (the total number of the second air cylinders 147 is four in this embodiment). The holding pins 147a are expandable according to the control signal of the second controller 148. The holding pins 147a when being expanded come in contact with the lower surface of the pallet 6 and lift up the pallet 6, thereby holding the pallet 6 spaced apart from the conveyer belts 115a, 115b of the upper belt conveyers 110a, 110b. As the holding pins 147a of the second air cylinders 147 are contracted according to the control signal of the second controller 148 from the state holding the pallet 6 spaced apart from the conveyer belts 115a, 115b, the pallet 6 is returned to be put on the conveyer belts 115a, 115b.

As shown in FIG. 4, the lower conveyer mechanism 12 has a pair of lower belt conveyers 120a, 120b that are supported between the lower frame members 134, 134 such that the lower belt conveyers 120a, 120b are spaced apart from each other by a predetermined distance to extend in parallel to each other and horizontally by using a plurality of long supporting frame members 136. The lower belt conveyers 120a, 120b have similar structure as the upper belt conveyers 110a, 110b of the aforementioned upper conveyer mechanism 11. As shown in FIG. 5, the lower belt conveyers 120a, 120b comprise long body members 121a, 121b, driving pulleys 123a, 123b and driven pulleys 124a, 124b rotatably mounted at the ends of the long body members 121a, 121b via mounting members 122, and endless conveyer belts 125a, 125b that are wound around the driving pulleys 123a, 123b and the driven pulleys 124a, 124b to extend therebetween. The left and right driving pulleys 123a, 123b are connected to each other through a driving shaft 126. Attached to the driving shaft 126 is a first sprocket 127c. A driving chain 128 is wound around the first sprocket 127c and a second sprocket 127d to extend therebetween. The second sprocket 127d is rotated by a driving motor 129 that is fixed to the lower surface of the supporting frame member 136, whereby the first sprocket 127c is rotated through the driving chain 128 and the driving pulleys 123a, 123b are rotated in synchronism with each other via the driving shaft 126. That is, the left and right conveyer belts 125a, 125b are rotated and moved in synchronism with each other by the driving motor 129 so as to move the pallet 6 on the conveyer belts 125a, 125b forward.

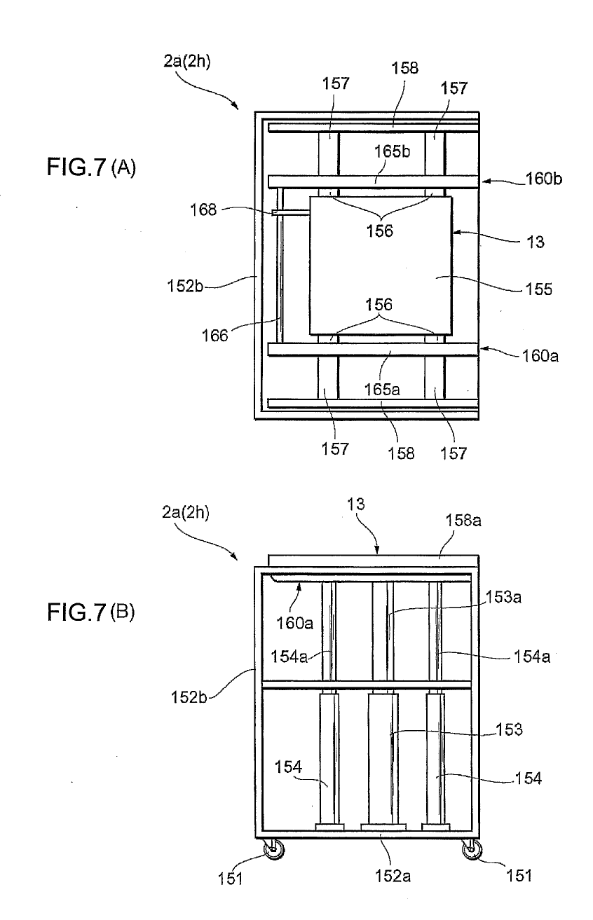

The loading station unit 2a and the collecting station unit 2h have the same structures. As shown in FIG. 7, each of the loading station unit 2a and the collecting station unit 2h has an elevation frame 152, comprising a rectangular plate-shape supporting base 152a that has a plurality of wheels 151 having locking mechanisms and is located at a predetermined height from the floor, and a wall-like frame 152b that stands on the supporting base 152a and comprises a frame section on the opposite side from the conveyer unit 10 and left and right side frame sections (having a U-like shape in a plan view), and an elevation unit 13, which is installed on the supporting base 152a.

The elevation unit 13 comprises an elevation cylinder 153, a plurality of (four in this embodiment) guide tubes 154, an elevation table 155, and a pair of left and right elevation belt conveyers 160a, 160b. The elevation cylinder 153 and the guide tubes 154 are standing on the supporting base 152a. The elevation table 155 having a plate-like shape is attached to an upper end of an expandable output rod 153a of the elevation cylinder 153 and upper ends of guide rods 154a, which are slidably fitted to the guide tubes 154. The elevation table 155 can move up and down in the vertical direction because of the expansion and contraction of the elevation cylinder 153 (the output rod 153a).

On the left and right sides of the elevation table 155, the pair of left and right belt conveyers 160a, 160b are disposed to extend in parallel to each other and horizontally by using a plurality of supporting frame members 156. The elevation belt conveyers 160a, 160b have the same structures as the upper belt conveyers 110a, 110b of the aforementioned upper conveyer mechanism 11 and thus comprise driving pulleys (not shown), driven pulleys (not shown), and endless conveyer belts 165a, 165b that are wound around the driving pulleys and the driven pulleys to extend therebetween. The left and right driving pulleys are connected to each other via a driving shaft 166 so that the conveyer belts 165a, 165b are rotated and moved in synchronism with each other via the driving chain 168 by the rotation of the driving motor (not shown) so as to move the pallet 6 on the conveyer belts 165a, 165b forward or rearward.

The elevation belt conveyers 160a, 160b move up and down together with the elevation table 155 by the expansion and contraction of the elevation cylinder 153 (the output rod 153a) and can abut the upper belt conveyers 110a, 110b of the upper conveyer mechanism 11 or the lower belt conveyers 120a, 120a of the lower conveyer mechanism 12 composing the printing station unit 2e. As a result, the delivery of the pallet 6 is allowed between the elevation belt conveyers 160a, 160b and the upper belt conveyers 110a, 110b or the lower belt conveyers 120a, 120b. On the left and right sides of the elevation belt conveyers 160a, 160b, long guide frame members 158, 158 extending along the elevation belt conveyers 160a, 160b using a plurality of supporting frame members 157 are arranged. On the outer surfaces of the guide frame members 158, 158, guide walls 158a, 158a are formed to extend upward along the outer surfaces of the guide frame members 158, 158, respectively, thereby preventing the pallet 6 on the belt conveyers 160a, 160b from deviating to the left or the right.

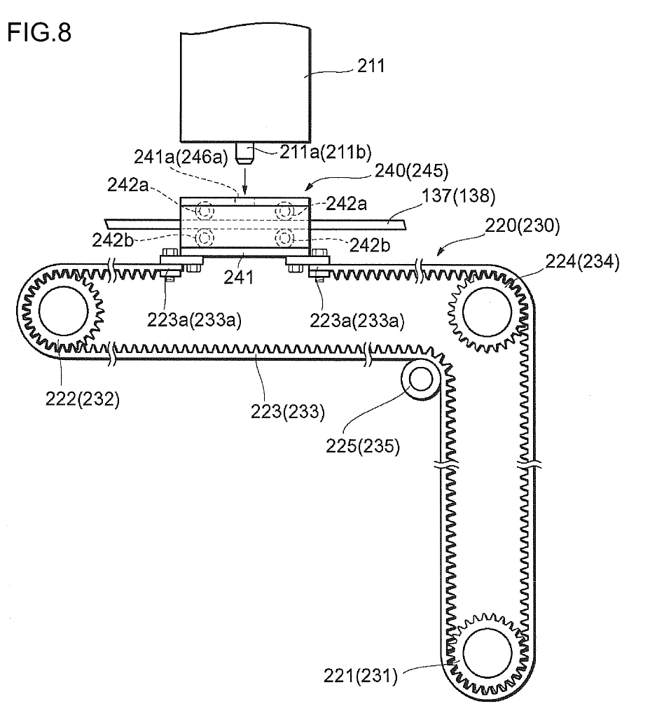

Hereinafter, the detailed structure of the printer unit 20 of the printing station unit 2e will be described with regard to FIG. 2, and FIG. 8 through FIG. 11. As shown in FIG. 2, the printer unit 20 (the printing unit 3e) comprises anteroposterior moving mechanisms 220, 230 that are arranged on left and right sides (at the positions corresponding to the first holding mechanism 140 (the first holding position) of the aforementioned upper conveyer mechanism 11) of the of the conveyer frame 130 of the conveyer unit 10, and a printer mechanism 210 that is detachably mounted to the anteroposterior moving mechanism 220, 230.

As shown FIG. 8, the anteroposterior moving mechanisms 220, 230 each comprise a driving sprocket 221, 231, a first driven sprocket 222, 232, a toothed belt 223, 233 that is wound around the driving sprocket 221, 231 and the first driven sprocket 222, 232 to extend therebetween, a second driven sprocket 224, 234, and a guide roller 225, 235 so that the toothed belt 223, 233 is arranged in an L-like shape of which top is the second sprocket 224, 234. It should be noted that each driving sprocket 221, 231 and each second driven sprocket 224, 234 (each guide roller 225, 235) are rotatably supported to be spaced apart from each other in the vertical direction on the left or right side of the conveyer frame 130, and each first driven sprocket 222, 232 and each second driven sprocket 224, 234 (each guide roller 225, 235) are rotatably supported to be spaced apart from each other in the anteroposterior direction on the left or right side of each upper frame member 133, 133. The toothed belts 223, 233 are connected via fitting members 240, 245 at their ends, respectively so that each toothed belt 223, 233 is formed into a ring shape. The fitting members 240, 245 are located between the first driven sprockets 222, 232 and the second driven sprocket 224, 234, respectively.

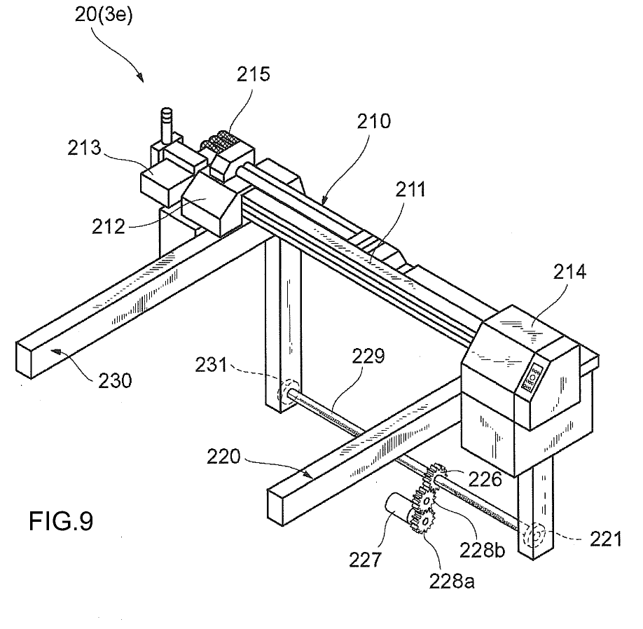

As shown in FIG. 9, the left and right driving sprockets 221, 231 are connected to each other via a driving shaft 229. Attached to a middle portion of the driving shaft 229 is a driving gear 226. A train of driving gears 228a, 228b is disposed to be meshed with the driving gear 226. The train of driving gears 228a, 228b is driven to be rotated by the driving motor 227 so as to rotate the driving gear 226, thereby rotating the left and right driving sprockets 221, 231 in synchronism with each other via the driving shaft 229. That is, the left and right toothed belts 223, 233 are rotated or moved in synchronism with each other by the driving motor 227 so that the left and right fitting members 240, 245 are moved in synchronism with each other in the anteroposterior direction along the upper frame members 133, 133 (the upper conveyer mechanism 11). The driving shaft 229, the driving motor 227, and the like are disposed below the lower frame members 134, 134 (the lower conveyer mechanism 12) so as not to interrupt the passage of the pallet 6.

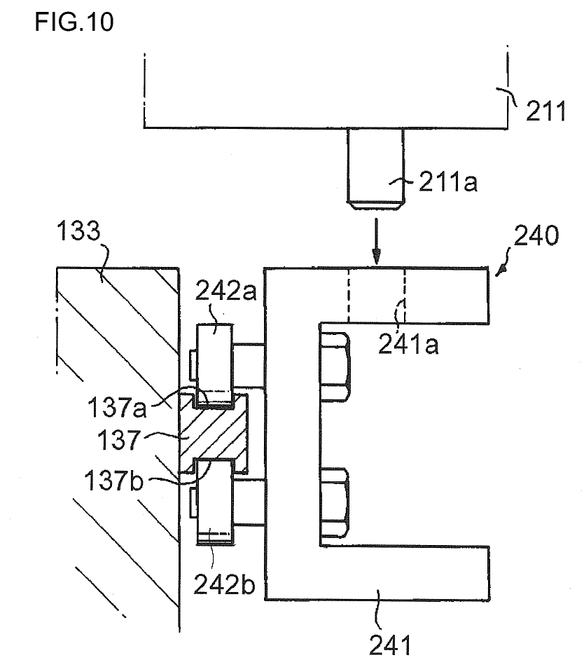

The fitting member 240 for connecting the toothed belt 223 in the left-side anteroposterior moving mechanism 220 is shown in FIG. 10. The fitting member 240 comprises a body member 241 having a U-like section and two pairs of guide rollers 242a, 242b attached to the side surface of the body member 241, in which the guide rollers 242a and 242b in each pair are aligned to be spaced apart from each other by a predetermined distance in the vertical direction and the pairs are mounted to be spaced apart from each other in the anteroposterior direction as shown in FIG. 8. On the other hand, a guide rail 137 extending horizontally in the anteroposterior direction is attached to the outer surface of the left-side upper frame 133 of the conveyer unit 10. The two pairs of guide rollers 242a, 242b are fitted into the guide groves 137a, 137b which are formed in the upper and lower surfaces of the guide rail 137 so that the fitting member 240 is guided by the guide rail 137 to move in the anteroposterior direction. The fitting member 240 is provided with an engaging hole 241 a formed in and penetrating the upper surface of the body member 241.

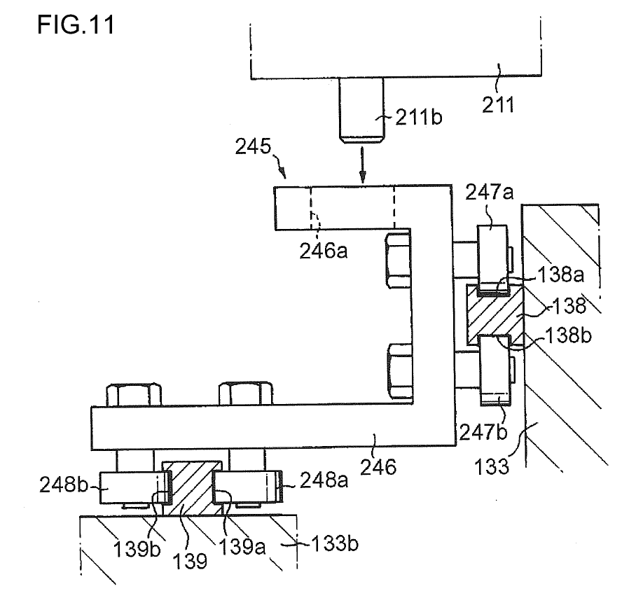

The fitting member 245 for connecting the toothed belt 233 in the right-side anteroposterior moving mechanism 230 is shown in FIG. 11. The fitting member 245 comprises a body member 246 having a U-like section with a longer lower side and two pairs of guide rollers 247a, 247b attached to the side surface of the body member 246, in which the guide rollers 247a and 247b in each pair are aligned to be spaced apart from each other by a predetermined distance in the vertical direction and the pairs are mounted to be spaced apart from each other in the anteroposterior direction. It should be understood that the guide rollers 247a, 247b are arranged in a bilaterally-symmetrical pattern with the guide rollers 242a, 242b of the fitting member 240 of the left-side anteroposterior moving mechanism 220. On the other hand, a guide rail 138 extending horizontally in the anteroposterior direction is attached to the outer surface of the right-side upper frame 133 of the conveyer unit 10. The two pairs of guide rollers 247a, 247b are fitted into the guide groves 138a, 138b, which are formed in the upper and lower surfaces of the guide rail 138 so that the fitting member 245 is guided by the guide rail 138 to move in the anteroposterior direction. The fitting member 245 is provided with an engaging hole 246a formed in and penetrating the upper surface of the body member 246.

Two pairs of guide rollers 248a, 248b attached to the lower surface of the outwardly extending lower side of the body member 246, in which the guide rollers 248a and 248b in each pair are aligned to be spaced apart from each other by a predetermined distance in the lateral direction and the pairs are mounted to be spaced apart from each other in the anteroposterior direction. On the right side of the upper frame 133 of the conveyer unit 10, a guide surface 133b facing upward and extending in the anteroposterior direction is formed and a guide rail 139 extending in the anteroposterior direction is attached to the guide surface 133b. The two pairs of guide rollers 248a, 248b are fitted into the guide groves 139a, 139b, which are formed in the left and right surfaces of the guide rail 139 so that the fitting member 245 is guided by the guide rail 139 to move in the anteroposterior direction. That is, the fitting member 245 can be guided by the guide rail 138 and the guide rail 139 both in the vertical direction and the lateral direction to move in the anteroposterior direction.

As apparent from the description of the structure, the left and right toothed belt 223, 233 are rotated and moved by driving the driving motor 227 so that the left and right fitting members 240, 245 can be moved in synchronism with each other in the anteroposterior direction. During this, the left side fitting member 240 is guided in the vertical direction accurately by the guide rail 137 and the right side fitting member 245 is guided in the in the vertical direction and the lateral direction accurately by the guide rails 138, 139 to move in the anteroposterior direction. The printer mechanism 210 is detachably attached to the left and right fitting members 240, 245, which are moved in synchronism with each other in the anteroposterior direction so that the printer mechanism 210 are entirely moved in the anteroposterior direction.

As shown in FIG. 2, the printer mechanism 210 comprises a long guide bar member 211 that extends in the lateral direction above the upper conveyer mechanism 11 (the upper belt conveyer 110a, 110b) and is mounted on the anteroposterior moving mechanisms 220, 230, a printer head 212 that is disposed movably along the guide bar member 211, and an ink supply device 213 and a maintenance station 214 that are mounted on the right and left ends of the guide bar member 211.

On the lower surface of the guide bar member 211, a pair of engaging projections 211a, 211b (see FIGS. 10, 11) are formed that are spaced apart from each other in the lateral direction (corresponding to a distance between the left and right fitting members 240, 245 of the anteroposterior moving mechanisms 220, 230) and project downward. The engaging projections 211a, 211b are fitted into the aforementioned engaging holes 241a, 246a formed in the upper surfaces of the left and right fitting members 240, 245, whereby the guide bar member 211 is detachably mounted. As a result, as the left and right fitting members 240, 245 are moved in synchronism with each other in the anteroposterior direction, the guide bar member 211 is also moved in the anteroposterior direction together.

The guide bar member 211 is provided with a guide rail (not shown) extending in the lateral direction. A printer head 212 is disposed on the guide bar member 211 such that the printer head 212 can be guided to move in the lateral direction. The guide bar member 211 is also provided with a driving belt (not shown). By controlling the operation of the driving belt, the printer head 212 is controlled to move in the lateral direction along the guide bar member 211. The printer head 212 has a large number of inkjet nozzles (not shown) formed in its lower surface to face downward. By ejection of ink droplets from the inkjet nozzles, printing of intended characters and/or images on print substrates 5 below the inkjet nozzles is conducted.

The ink supply device 213 is mounted on the right end of the guide bar member 211. The maintenance station 214 is mounted on the left end of the guide bar member 211. The maintenance station 214 has a device that retracts the printer head 212 into the maintenance station 214, and aspirates and cleans the remaining ink in the inkjet nozzles. In addition to the ink supply device 213, disposed on the right end portion of the guide bar member 211 is a controller (not shown) for controlling the movement of the printer head 212 and controlling the ejection of ink droplets from the inkjet nozzles formed in the lower surface of the printer head 212.

A cable guide 215 connecting the guide bar member 211 and the printer head 212 is provided. Wires for sending electric power and signals and flexible tubes for supplying ink are arranged within the cable guide 215. According to this structure, electric power, control signals, and ink can be supplied from the side of the guide bar member 211 (from the ink supply device 213 and the like) to the printer head 212.

Below the conveyer unit 10, a power source and a control equipment (not shown) are disposed and flexible cable guide (not shown) is disposed. In the flexible cable guide, cables for sending electric power and control signals from the power source and the control equipment to control the upper and lower conveyer mechanisms 11, 12 (the driving motors 119, 129) and the first and second holding mechanism 140, 145 (the first and second controllers 143, 148) of the conveyer unit 10, the elevation cylinder 153 of the elevation unit 13, the anteroposterior moving mechanisms 220, 230 (the driving motor 227), and the printer mechanism 210 (the ink supply device 213, the controller, and the maintenance station 214) of the printer unit 20 are arranged.

A series of actions of the printing apparatus 1′ having the aforementioned structure will be described. First, by an operator, print substrates 5 are put on the respective loading tables 8 of the first pallet 6 on the elevation belt conveyers 160a, 160b of the elevation unit 13 in the loading station unit 2a. The first pallet 6 holding the print substrates 5 thereon is moved to the upper belt conveyers 110a, 110b of the upper conveyer mechanism 11, which abut the elevation belt conveyers 160a, 160b, that is, the first pallet 6 is conveyed to the printing station unit 2e.

In the printing station unit 2e, first the locating pins 141a of the first sensors 141 composing the first holding mechanism 140 disposed on the upper conveyer mechanism 11 are in the expanded state and the locating pins 146a of the second sensors 146 composing the second holding mechanism 145 disposed on the upper conveyer mechanism 11 are in the contracted state. The first pallet 6 conveyed to the printing station unit 2e is moved backward on the upper belt conveyers 110a, 110b so that the cutouts 6a formed in the rear side of the first pallet 6 come in contact with the locating pins 141a of the first sensors 141 (the first pallet 6 is located at its working position). As the cutouts 6a of the first pallet 6 come in contact with the locating pins 141a, the holding pins 142a of the first air cylinders 142 are expanded according to a control signal from the first controller 143 so as to lift up the first pallet 6, thereby holding the pallet 6 spaced apart from the conveyer belts 115a, 115b of the upper belt conveyers 110a, 110b. As the first pallet 6 is held in the state spaced apart from the conveyer belts 115a, 115b, the locating pins 141a of the first air cylinders 141 are contracted and the locating pins 146a of the second sensors 146 are expanded.

As the first pallet 6 is held at the first holding position (the working position) by the first holding mechanism 140, the printed surfaces of the print substrates 5 on the pallet 6 and the printer head 212 (the inkjet nozzles) of the printer mechanism 210 are held in a state facing each other with a certain distance (about 2 mm) therebetween. In this state, ink droplets are ejected from the inkjet nozzles while the printer mechanism 210 is moved in the anteroposterior direction above the print substrates 5 on the first pallet 6 by the anteroposterior moving mechanisms 220, 230, and the printer head 212 is moved in the lateral direction along the guide bar member 211, thereby conducting printing of intended characters, images, and the like on the respective print substrates 5. In a stable state relative to the print substrates 5 without being affected by vibration of the upper belt conveyers 110a, 110b, higher precise printing can be achieved by the printer mechanism 210. By the drive control of the anteroposterior moving mechanisms 220, 230, the movement control of the printer head 212, and the ejection control of ink from the inkjet nozzles, different characters, images and the like can be printed on the respective print substrates 5 aligned in the lateral direction and held on the pallet 6, respectively.

On the other hand, when printing step is conducted by the printer unit 20 in a state that the first pallet 6 is held at the first holding position, new print substrates 5 are put on the respective loading tables 8 of the second pallet 6 on the elevation belt conveyers 160a, 160b of the elevation unit 13 by the operator in the loading station unit 2a. The second pallet 6 holding the print substrates 5 thereon is moved to the upper belt conveyers 110a, 110b of the upper conveyer mechanism 11 which about the elevation belt conveyers 160a, 160b, that is, the second pallet 6 is conveyed to the printing station unit 2e.

The second pallet 6 conveyed to the printing station unit 2e is moved backward on the upper belt conveyers 110a, 110b so that the cutouts 6a formed in the rear side of the second pallet 6 come in contact with the locating pins 146a of the second sensors 146 (the second pallet 6 is located at its standby position). As the cutouts 6a of the second pallet 6 come in contact with the locating pins 146a, the holding pins 147a of the second air cylinders 147 are expanded according to a control signal from the second controller 148 so as to lift up the second pallet 6, thereby holding the second pallet 6 spaced apart from the conveyer belts 115a, 115b of the upper belt conveyers 110a, 110b. As the second pallet 6 is held in the state spaced apart from the conveyer belts 115a, 115b, the locating pins 146a of the second sensors 146 are contracted (the locating pins 141a of the first sensors 141 are kept in the contracted state).

As the second pallet 6 is held at the second holding position (the standby position) by the second holding mechanism 145 and then the printing step by the printer unit 20 relative to the first pallet 6 held at the first holding position is completed, the holding pins 142a of the first air cylinders 142 are contracted according to the control signal of the first controller 143 so that the first pallet 6 is returned onto the conveyer belts 115a, 115b. The first pallet 6 returned onto the conveyer belts 115a, 115b is moved to be on the elevation belt conveyers 160a, 160b of the collecting station unit 2h which abut to the upper belt conveyers 110a, 110b so that the first pallet 6 is conveyed to the collecting station unit 2h. As the first pallet 6 is conveyed to the collecting station unit 2h, the locating pins 141a of the first sensors 141 are expanded (the locating pins 146a of the second sensors 146 are kept in the contracted state).

As the first pallet 6 is conveyed to the collecting station unit 2h, the respective print substrates 5 after completing the printing step on the first pallet 6 are collected by the operator. The first pallet 6 after the print substrates 5 are collected is moved to the lower belt conveyers 120a, 120b of the lower conveyer mechanism 12 which abut the elevation belt conveyers 160a, 160b by the operation of the elevation unit 13 (the elevation cylinder 153) so that the first pallet 6 is conveyed to the printing station unit 2e again. The first pallet 6 conveyed to the printing station unit 2e is conveyed on the lower belt conveyers 120a, 120b toward the loading station unit 2a. In the loading station unit 2a, new print substrates 5 are put on the first pallet 6 and are then subjected to the same step as mentioned above.

On the other hand, as the first pallet 6 is conveyed to the collecting station unit 2h, the holding pins 147a of the second air cylinders 147 are contracted according to a control signal of the second controller 148 so that the second pallet 6 is returned onto the conveyer belts 115a, 115b. The second pallet 6 returned onto the conveyer belts 115a, 115b are moved backward on the upper belt conveyer 110a, 110b so that the cutouts 6a formed in the rear side of the second pallet 6 come in contact with the locating pins 141a of the first sensors 141 (the second pallet 6 is located at its working position). As the cutouts 6a of the second pallet 6 come in contact with the locating pins 141a, the holding pins 142a of the first air cylinders 142 are expanded according to a control signal from the first controller 143 so as to lift up the second pallet 6, thereby holding the second pallet 6 spaced apart from the conveyer belts 115a, 115b of the upper belt conveyers 110a, 110b. After that, similarly to the aforementioned first pallet 6, the second pallet 6 is subjected to the printing step by the printer unit 20, the conveyance to the collecting station unit 2h, the collection of the print substrates 5, and the conveyance to the loading station unit 2a in this order. Even when processing operations are conducted concurrently by a plurality of working devices like the aforementioned case, it is not necessary to keep the next pallet waiting until all of the processing operations are terminated because it is possible to make the second pallet 6 wait by the second holding mechanism 145, thereby preventing reduction in the operation rates of the working devices.

As mentioned above, though the detailed structure and the actions of the conveyer unit 10 and the elevation unit 13 have been described with regard to the printing apparatus 1′ in which the loading station unit 2a, the printing station unit 2e, and the collecting station unit 2h are aligned to abut each other as shown in FIG. 2, work station units such as the preprocessing station unit 2b, the first drying station unit 2c, are further aligned to abut in addition to the above three work station units in the printing apparatus of this embodiment as shown in FIG. 1. Therefore, in the printing apparatus 1, besides the actions mentioned above, an action for delivering the pallet from a conveyer unit 10 to a conveyer unit 10 of another work station unit is generated.

Hereinafter, for example, the action for delivering the pallet 6 from the conveyer unit 10 (the upper conveyer mechanism 11) of the printing station unit 2e to the conveyer unit 10 (the upper conveyer mechanism 11) of the post-processing station unit 2f will be described. In the printing station unit 2e, as the printing step relative to the first pallet 6 held at the first holding position is completed by the printer unit 20 as mentioned above, the first pallet 6 is returned onto the conveyer belts 115a, 115b by the first holding mechanism 140. The first pallet 6 returned onto the conveyer belts 115a, 115b is moved to the upper belt conveyers 110a, 110b of the post-processing station unit 2f which abut the upper belt conveyers 110a, 110b of the printing station unit 2e so that the first pallet 6 is conveyed to the post-processing station unit 2f. As the first pallet 6 is conveyed to the post-processing station unit 2f, the locating pins 141a of the first sensors 141 of the printing station unit 2e are in the expanded state and the locating pins 146a of the second sensors 146 are in the contracted state.

In the post-processing station unit 2f, first the locating pins 141a of the first sensors 141 composing the first holding mechanisms 140 disposed on the upper conveyer mechanism 11 are in the expanded state and the locating pins 146a of the second sensors 146 composing the second holding mechanism 145 disposed on the upper conveyer mechanism 11 are in the contracted state. The first pallet 6 conveyed to the post-processing station unit 2f is moved backward on the upper belt conveyers 110a, 110b and is held at the first holding position (the working position of the post-processing unit 3f) spaced apart from the conveyer belts 115a, 115b by the first holding mechanism 140. The first pallet 6 is held at the first holding position by the first holding mechanism 140, the post-processing unit 3f conducts the post-processing step by applying a protective coating material to the surfaces of the print substrates 5, on which characters, images, and the like were printed by the printer unit 20, to protect and coat the surfaces. As the first pallet 6 is held at a position spaced apart from the conveyer belts 115a, 115b, the locating pins 141a of the first sensors 141 of the post-processing station unit 2f are in the contracted state and the locating pins 146a of the second sensors 146 of the post-processing station unit 2f are in the expanded state.

On the other hand, as the first pallet 6 is conveyed to the post-processing station unit 2f, the second holding mechanism 145 returns the second pallet 6 onto the conveyer belts 115a, 115b in the printing station unit 2e. The second pallet 6 returned onto the conveyer belts 115a, 115b is moved backward on the upper belt conveyers 110a, 110b and is held at the first holding position (the working position of the printer unit 20) spaced apart from the conveyer belts 115a, 115b by the first holding mechanism 140. As the second pallet 6 is held at the first holding position by the first holding mechanism 140, the printer unit 20 prints intended characters, images, and the like on the respective print subjects 5 held on the second pallet 6. As the second pallet 6 is held at a position spaced apart from the conveyer belts 115a, 115b, the locating pins 141a of the first sensors 141 of the printing station unit 2e are in the contracted state and the locating pins 146a of the second sensors 146 of the printing station unit 2e are in the expanded state.

As the printing step by the printer unit 20 relative to the second pallet 6 held at the first holding position is terminated, the first holding mechanism 140 returns the second pallet 6 onto the conveyer belts 115a, 115b. The second pallet 6 returned onto the conveyer belts 115a, 115b is moved to the upper belt conveyers 110a, 110b of the post-processing station unit 2f which abut the upper belt conveyers 110a, 110b of the printing station unit 2e. The second pallet 6 conveyed to the post-processing station unit 2f is moved backward on the upper belt conveyers 110a, 110b and is held at a second holding position (the standby position of the post-processing station unit 2f) spaced apart from the conveyer belts 115a, 115b of the upper belt conveyer 110a, 110b by the second holding mechanism 145. In a case where the first pallet 6 after the post-processing is already conveyed to the following second drying station unit 2g when the second pallet 6 is conveyed to the post-processing station unit 2f, the second pallet 6 is held directly at the first holding position (the working position of the post-processing unit 3f) by the first holding mechanism.

After the post-processing by the post-processing unit 3f relative to the first pallet 6 held at the first holding position is terminated in the post-processing station unit 2f, the first pallet 6 is returned onto the conveyer belts 115a, 115b by the first holding mechanism 140. The first pallet 6 returned onto the conveyer belts 115a, 115b is moved to the upper belt conveyers 110a, 110b of the second drying station unit 2g which abut the upper belt conveyers 110a, 110b of the post-processing station unit 2f so that the first pallet 6 is conveyed to the second drying station unit 2g. After that, similarly to the above, the first pallet 6 is subjected to the drying step by the drying unit 3g, the conveyance to the collecting station unit 2h, the collection of the print substrates 5, and the conveyance to the loading station unit 2a in this order.

In the post-processing station unit 2f, the second pallet 6 is returned to the conveyer belts 115a, 115b by the second holding mechanism, is moved backward on the upper belt conveyers 110a, 110b, is held at the first holding position (the working position of the post-processing unit 3f) spaced apart from the conveyer belts 115a, 115b by the first holding mechanism 140, and is then subjected to the post-processing by applying a protective coating material to the surfaces of the print substrates 5, on which characters, images, and the like were printed by the printer unit 20, to protect and coat the surfaces. After that, similarly to the aforementioned first pallet 6, the second pallet 6 is subjected to the conveyance to the drying station unit 2g, the drying step by the drying unit 3g, the conveyance to the collecting station unit 2h, the collection of the print substrates 5, and the conveyance to the loading station unit 2a in this order.

Though the above description has been made with regard to the first pallet 6 and the second pallet 6, a larger number of pallets 6 such as the third pallet 6, the forth pallet 6, etc. can be conveyed sequentially and circulated by the respective station units 2a through 2g and subjected to respective processing operations by the work units 3b through 3f in the printing apparatus 1 according to this embodiment.

As mentioned in the above, the printing apparatus 1 comprises the respective station units 2a through 2h, corresponding to the respective processing operations to be conducted to print substrates 5, which are aligned adjacent to each other. The station units 2b through 2g have the conveyer units 10 for conveying the pallet 6 holding the print substrates 5 thereon, respectively. The upper conveyer mechanisms 11 and the lower conveyer mechanisms 12 of the respective conveyer units 10 are placed in a uniform way such that ends as the pallet receiving portions and the pallet let-off portions of the respective upper conveyer mechanisms 11 are surely abutted to each other and also ends as the pallet receiving portions and the pallet let-off portions of the respective lower conveyer mechanisms 12 are surely abutted to each other. Accordingly, the delivery of the pallet 6 between the station units is allowed, whereby intended characters, images, etc. can be printed by the respective work units 3b through 3g sequentially conducting the processing operations relative to the print substrates 5.

In the printing apparatus 1, each of the station units 2a through 2h comprises each elevation unit 13 or each work unit (the preprocessing unit 3b, the drying unit 3c, 3g, the undercoating unit 3d, the printing unit 3e, the post-processing unit 3f) and each conveyer unit 10 (the upper conveyer mechanism 11 and the lower conveyer mechanism 12) which are mounted to the frame body (the conveyer frame 130) of each station unit and thus can be replaced or rearranged integrally with each frame body. Therefore, it is possible to change and set the processing steps for printing operation. As mentioned above, it is possible to flexibly meet needs for increase or reduction of printing steps and change of layout according to the kind of print substrates and the production condition, thereby making the printing apparatus suitable for high-mix low-volume production type printing.

In the printing apparatus 1, the loading station unit 2a and the collecting station unit 2h are arranged on both ends. The loading station unit 2a and the collecting station unit 2h each comprise an elevation unit 13 for conveying the pallet 6 between the upper conveyer mechanism 11 and the lower conveyer mechanism 12. The elevation unit 13 moves up and down to abut itself to the ends as the pallet receiving portion and the pallet let-off portion of the upper conveyer mechanism 11 and the lower conveyer mechanism 12 so as to allow the delivery of the pallet 6 between the upper conveyer mechanism 11 and the lower conveyer mechanism 12. Therefore, the pallet 6 can be conveyed and circulated through the respective station units 2a through 2h by the elevation units 13 and the respective conveyer units 10 (the upper conveyer mechanism 11 and the lower conveyer mechanism 12), thereby improving the efficiency of print work.

Though the present invention has been described with regard to the preferred embodiments, the printing apparatus of the present invention is not limited to the structures of the aforementioned embodiments and printing apparatuses with various modifications and changes from the aforementioned embodiment are also included in the present invention.

It should be noted that the exemplary embodiments depicted and described herein set forth the preferred embodiments of the present invention, and are not meant to limit the scope of the claims hereto in any way. Numerous modifications and variations of the present invention are possible in light of the above teachings. It is therefore to be understood that, within the scope of the appended claims, the invention may be practiced otherwise than as specifically described herein.

What is claimed is:

1. A printing apparatus for printing on a print substrate by sequentially conducting a plurality of processing operations, said printing apparatus comprising:
a pallet configured to receive the print substrate; and
work station units each comprising a conveyer mechanism configured to convey said pallet and a work mechanism configured to conduct a predetermined processing operation to the print substrate on said pallet,
wherein a plurality of said work station units are aligned adjacent to each other, and
wherein said work station units are configured to be replaceable or rearrangeable to change the sequence of the plurality of processing operations.

2. The printing apparatus as claimed in claim 1, wherein said conveyor mechanisms have pallet receiving portions and pallet let-off portions located to allow delivery of said pallet between said conveyer mechanisms of said work station units.

3. The printing apparatus as claimed in claim 2, further comprising:
a circulating conveyer system configured to connect said pallet let-off portion of an anterior end work station unit and said pallet receiving portion of a posterior end work station unit so as to allow delivery of said pallet from said anterior end work station unit to said posterior end work station unit,
wherein said anterior end work station unit is one of said work station units disposed at an anterior end of a line of said work station units aligned adjacent to each other and said posterior end work station unit is another one of said work station units disposed at a posterior end of the line.

4. A printing apparatus for printing on a print substrate by sequentially conducting a plurality of processing operations, said printing apparatus comprising:
a pallet configured to receive the print substrate; and
work station units each comprising means for conveying said pallet and means for conducting a predetermined processing operation to the print substrate on said pallet,
wherein a plurality of said work station units are aligned adjacent to each other, and
wherein said work station units are configured to be replaceable or rearrangeable to change the sequence of the plurality of processing operations.

5. The printing apparatus as claimed in claim 4, wherein said means for conveying have pallet receiving portions and pallet let-off portions located to allow delivery of said pallet between said means for conveying of said work station units.

6. The printing apparatus as claimed in claim 5, further comprising:
means for connecting said pallet let-off portion of an anterior end work station unit and said pallet receiving portion of a posterior end work station unit so as to allow delivery of said pallet from said anterior end work station unit to said posterior end work station unit,
wherein said anterior end work station unit is one of said work station units disposed at an anterior end of a line of said work station units aligned adjacent to each other and said posterior end work station unit is another one of said work station units disposed at a posterior end of the line.

7. A method of printing on a print substrate, said method comprising:
providing a print substrate on a pallet;
providing a plurality of work station units aligned adjacent to each other, the plurality of work station units each comprising a conveyer mechanism configured to convey the pallet and a work mechanism configured to conduct a predetermined processing operation to the print substrate on the pallet;
conveying the pallet using the conveyer mechanisms; and
sequentially conducting a plurality of the predetermined processing operations to the print substrate on the pallet,
wherein the plurality of work station units are configured to be replaceable or rearrangeable to change the sequence of the plurality of the predetermined processing operations.

8. The method as claimed in claim 7, wherein the conveyor mechanisms have pallet receiving portions and pallet let-off portions located to allow delivery of the pallet between the conveyer mechanisms of the work station units.

9. The method as claimed in claim 8, further comprising:
providing a circulating conveyer system configured to connect the pallet let-off portion of an anterior end work station unit and the pallet receiving portion of a posterior end work station unit so as to allow delivery of the pallet from the anterior end work station unit to the posterior end work station unit,
wherein the anterior end work station unit is one of the work station units disposed at an anterior end of a line of the work station units aligned adjacent to each other and the posterior end work station unit is another one of the work station units disposed at a posterior end of the line.
